(19) United States
(12) Patent Application Publication
(10) Pub. No.: US 2009/0190255 A1
(43) Pub. Date: Jul. 30, 2009

(54) Method and for wide track erasure in a hard disk drive

(75) Inventor: Eun Kyu Jang, San Jose, CA (US)

Correspondence Address: GREGORY SMITH & ASSOCIATES, 3900 NEWPARK MALL ROAD, 3RD FLOOR, NEWARK, CA, 94560, US

(73) Assignee: Samsung Electronics Co., LTD.

(21) Appl. No.: 12/011,365

(22) Filed: Jan. 24, 2008

(51) Int. Cl. G11B 5/33

(52) U.S. Cl. 360/118

(57) ABSTRACT

A hard disk drive is disclosed with a slider including a wide track eraser for erasing neighboring tracks and the servo patterning around a track on the accessed disk surface. Using the wide track eraser reduces the time to erase a disk surface by at least a factor of N, where N is at least 4, and may preferably be successively larger to at least 64. Embodiments include the slider, a head gimbal assembly, a main flex circuit, an integrated circuit for the main flex circuit for stimulating the wide track eraser, a head stack assembly including the main flex circuit coupling through the head gimbal assembly to the wide track eraser, a control circuit, and a processor within the control circuit controlling the stimulus of the wide track eraser to erase part or all of a disk surface.

### TECHNICAL FIELD

This invention relates to fast and secure erasing of data in a hard disk drive without disassembling the hard disk drive or relying on external bulk erasers.

### BACKGROUND OF THE INVENTION

Today, disks and disk drives frequently need to be securely erased. Most erasure methods for hard disk drives generally increase the security of the erasure by increasing the erasure time. Most if not all erasure methods either destroy the recording media or overwrite the recording media using a very strong magnetic field. Generating a strong field is often be done by placing the disk, disk cartridge and/or the entire hard disk drive in a bulk-erasing unit.

Erasure also occurs in the hard disk drive manufacturing process. If an assembled drive has a faulty servo pattern, everything down to the servo-pattern must be erased to rebuild the servo-write patterning on its disk surfaces. This requires disassembling the disk drive and bulk erasing the disks which adds even more problems. A method of reworking assembled hard disk drives is needed that neither uses large external magnetic fields nor requires the disassembly of the hard disk drive.

### SUMMARY OF THE INVENTION

Embodiments of the invention include a slider including a wide track eraser for erasing adjacent tracks and the servo patterning associated with the tracks on the accessed disk surface in a hard disk drive. Using the wide track eraser reduces the time to erase a disk surface significantly by erasing multiple tracks at once. The time reduction is related to the number of tracks simultaneously erased. This slider and its hard disk drive provide a time reduction of at least a factor of N, where N may be considered the number of tracks erased. N is at least 4, and may preferably be successively larger to at least 1024. N may approximate the ratio of the erasure pole width to the writer width.

The wide track eraser may include an eraser coil wrapped around an eraser pole. Alternatively, the wide track eraser may include a pancake coil wrapped about a coupling between two eraser poles. The read head of the slider may employ a magneto-resistive effect, for example, the giant magneto-resistive effect or the tunneling magneto-resistive effect. The write head may support a longitudinal recording scheme or a perpendicular recording scheme. The slider may or may not include a vertical micro-actuator.

Embodiments of the invention may include a head gimbal assembly, a main flex circuit, an integrated circuit for the main flex circuit for stimulating the wide track eraser, a head stack assembly including the main flex circuit coupling through the head gimbal assembly to the wide track eraser, a control circuit, and a processor within the control circuit controlling the stimulus of the wide track eraser to erase part or all of a disk surface.

### BRIEF DESCRIPTION OF THE DRAWINGS

FIG. 1 shows an example of an embodiment of the invention as a hard disk drive including a disk base to which a spindle motor is mounted. The spindle motor is rotatably coupled to at least one disk to create at least one rotating disk surface. A voice coil motor is also pivotably mounted to the disk base and includes at least one actuator arm for moving a head gimbal assembly to position a slider near a track on the rotating disk surface. The slider includes a wide track eraser and the voice coil motor is configured to move the head gimbal assembly to position the wide track eraser near a track to erase it, adjacent tracks, and the servo patterning associated with the tracks on the rotating disk surface. A control circuit is configured to control stimulating the wide track eraser to erase around the track.

FIG. 2A shows some details of the voice coil motor of FIG. 1 including a head stack assembly including a main flex circuit with an integrated circuit, with the voice coil, the actuator pivot, the actuator arm, and the head gimbal assemblies of FIG. 1.

FIG. 2B shows an example of the head gimbal assembly of FIG. 2A with a slider including a wide track eraser.

FIG. 3 shows some details of the hard disk drive of FIG. 1, where the control circuit controlling the wide track eraser further includes a processor controlling an eraser control signal to stimulate the wide track eraser to erase erasing adjacent tracks and the servo patterning associated with the tracks of the rotating disk surface. The processor may include at least one instance of a controller and at least one of the controllers may include a computer accessibly coupled via a buss to a computer readable memory. The computer may be directed by a program system that includes program steps residing in the memory. The memory may also include the track and/or a track increment. The number of tracks erased in one operation will be referred to as N. N may be at least four, and may preferably be successively larger to at least 1024. N may approximate the ratio of the erasure pole width to the writer width of various embodiments of the slider that will be discussed shortly. Successive erasures may be offset by a track increment that may be less than that.

FIG. 4 shows some details of the program system of FIG. 3 including stimulating the wide track eraser to erase the rotating disk surface around the track, erasing the rotating disk surface using the wide track eraser every track increment to create an erased disk surface and/or servo-writing the erased disk surface to create a formatted disk surface.

FIG. 5A shows some details of an embodiment of the head stack assembly where the main flex circuit includes an integrated circuit at least partly creating the eraser control signal to stimulate the wide track eraser. The slider is shown further including a write head and a read head. Various embodiments of the invention include sliders with differing orderings of the wide track eraser, the read head and the write head with regards the trailing edge of the slider. In this example, the write head is closest, next the read head and then the wide track eraser.

FIG. 5B shows an example of the control circuit including a channel interface at least partly controlling the eraser control signal. The processor is controllably coupled to the channel interface and the slider includes the write head closest to the trailing edge, followed by the wire track eraser, then the read head.

FIG. 5C shows another example of the slider with the wide track eraser closest to the trailing edge.

FIG. 5D shows the slider further including a vertical micro-actuator, preferably using a thermal mechanical property and referred to herein as a heater.

FIG. 6A shows a layer diagram taken in the cross section of an embodiment of the slider including a longitudinal recording write head closest to the trailing edge, followed by a heater, then a giant magneto-resistive read head and then a wide track eraser. The wide track eraser includes an eraser coil wrapped around a wide track erasure pole.

FIG. 6B shows the layers the slider of FIG. 6A as seen from the rotating disk surface. The writer width and the erasure pole width are shown.

FIG. 6C shows some details of the wide track eraser including the eraser coil wrapped around the wide track erasure pole seen in cross section through the cut line A-A of FIG. 6B.

FIG. 7A shows an embodiment of the slider including a perpendicular recording write head, followed by a heater, then a tunneling magneto-resistive read head, and then a wide track eraser. The wide track eraser includes a pancake coil wrapped about the coupling of a first eraser pole and a second eraser pole.

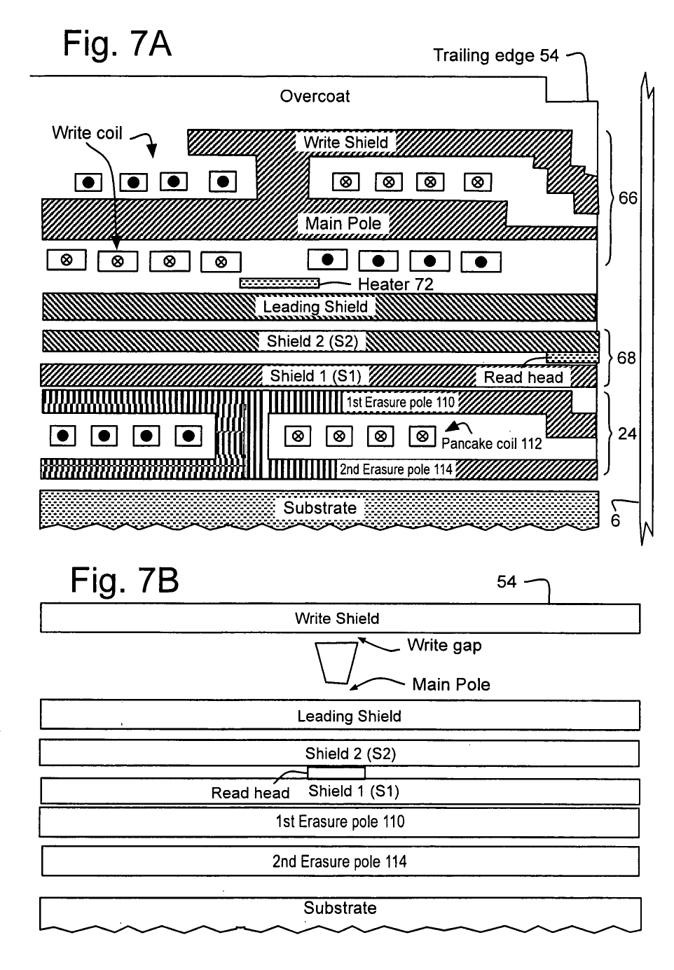

And FIG. 7B shows the layers the slider of FIG. 8A as seen from the rotating disk surface.

### DETAILED DESCRIPTION

This invention relates to apparatus and methods for fast and secure erasing of data in a hard disk drive without disassembling the hard disk drive or relying on external bulk erasers.

Embodiments of the invention include a slider including a wide track eraser for erasing adjacent tracks and the servo patterning associated with the tracks on the accessed disk surface in a hard disk drive. Using the wide track eraser reduces the time to erase a disk surface significantly by erasing multiple tracks at once. The time reduction is related to the number of tracks simultaneously erased. This slider and its hard disk drive provide a time reduction of at least a factor of N, where N may be considered the number of tracks erased. N is at least 4, and may preferably be successively larger to at least 1024. N may approximate the ratio of the erasure pole width to the writer width. Successive erasures may be offset by a track increment that is less than that.

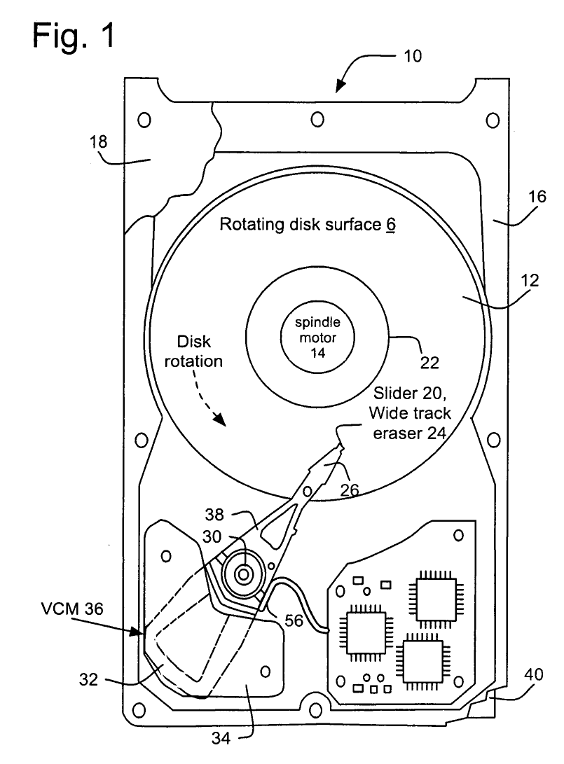

Referring to the drawings more particularly by reference numbers, FIG. 1 shows in a schematic fashion an embodiment of the invention as a hard disk drive 10 including a disk base 16 to which a spindle motor 14 is mounted. The spindle motor is rotatably coupled to at least one disk 12 to create at least one rotating disk surface 6. A voice coil motor 36 is also pivotably mounted to the disk base and includes at least one actuator arm 38 for moving a head gimbal assembly 26 to position a slider 20 near a track 22 on the rotating disk surface. The slider includes a wide track eraser 24 and the voice coil motor is configured to move the head gimbal assembly to position the wide track eraser to erase around a track on the rotating disk surface. A control circuit 40 is configured to control stimulating the wide track eraser to erase around the track. The voice coil motor further includes a voice coil 32 coupled to the actuator arm and pivoting about the actuator pivot 30 to move the head gimbal assembly in response to the interaction between the voice coil and a fixed magnet assembly 34 mounted on the disk base. A disk cover 18 is mounted upon the disk base to encapsulate all of the shown components except the control circuit, which is usually mounted on the opposite side of the disk base.

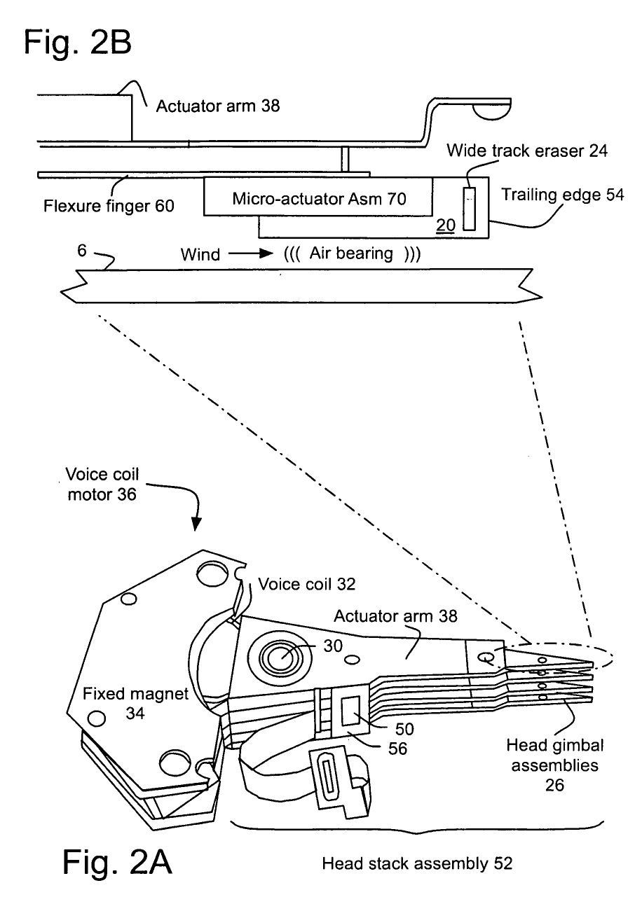

FIG. 2A shows some details of the voice coil motor 36 of FIG. 1 including a head stack assembly 52 that includes a main flex circuit 56 with an integrated circuit 50, as well as the voice coil 32, the actuator pivot 30, the actuator arm 38, and the head gimbal assemblies 26 previously shown in FIG. 1. In certain embodiments, the integrated circuit may be located elsewhere, for example, may be included in the control circuit 40.

FIG. 2B shows some details of an example of the head gimbal assembly 26 of previous Figures with the slider 20 including a wide track eraser 24 preferably near the trailing edge 24. The slider is electrically coupled with the flexure finger 60. The rotating disk surface creates a wind that provides the lift to create an air bearing upon which the slider floats a short distance above the disk surface.

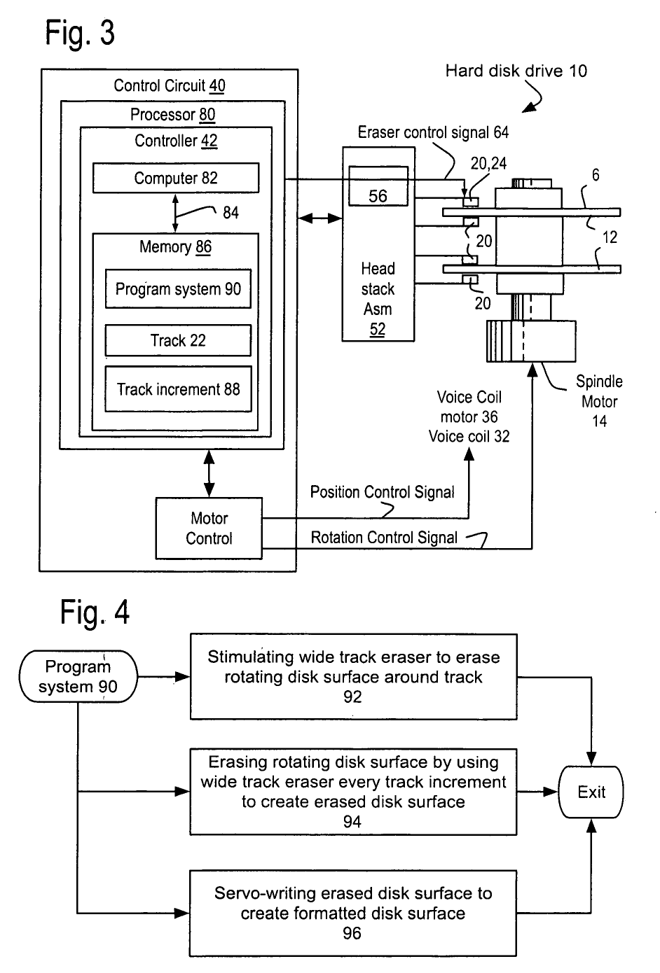

FIG. 3 shows some details of the hard disk drive 10 of FIG. 1, where the control circuit 40 controlling the wide track eraser 24 further includes a processor 80 controlling an eraser control signal 64 to stimulate the wide track eraser to erase around the track 24 of the rotating disk surface 6 as shown in FIG. 1. The processor may include at least one instance of a controller 42. As used herein a controller receives at least one input, maintains, and updates at least one state, and generates at least one output based upon at least one of the inputs, and/or at least one of the states. Unlike writing and reading tracks, the positioning of the slider is done only through stimulus of the voice coil 20 by a position control signal that is frequently generated by a motor control circuit that may or may not be part of the control circuit. The spindle motor is stimulated by a rotation control signal preferably controlled by the control circuit and may be generated by the same motor control circuit.

At least one controller 42 may include a finite state machine, which may be implemented using a programmable logic device such as a field programmable gate array or as an application specific integrated circuit. At least one of the controllers may include a computer 82 accessibly coupled 84 via a buss to a computer readable memory 86. The computer may be directed by a program system 90 that may include program steps residing in the memory. As used herein, a computer may include at least one data processor and at least one instruction processor directed by the program system. Each of the data processors is at least partly instructed by at least one of the instruction processors.

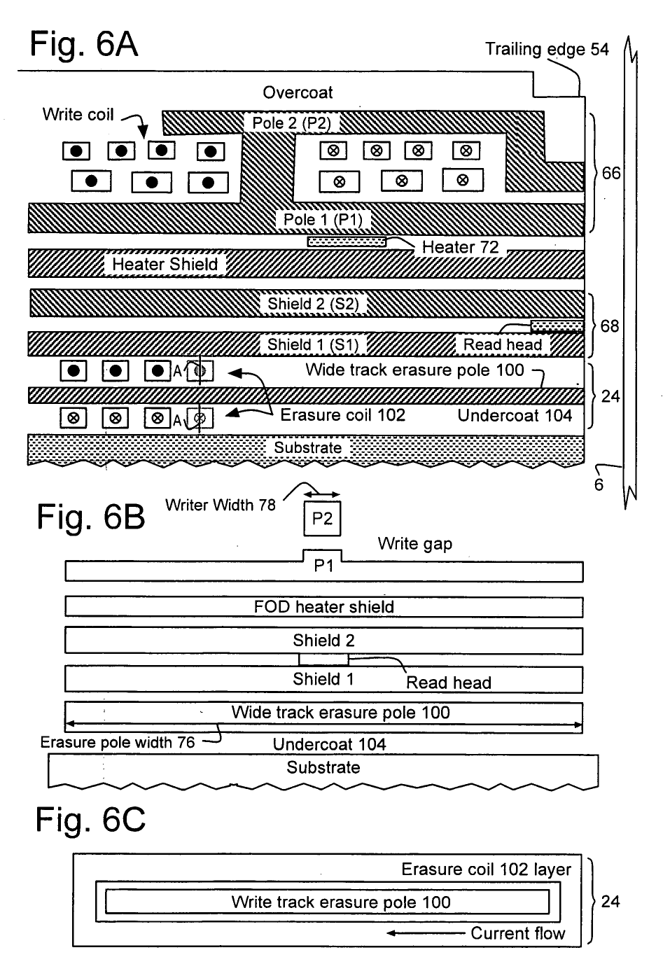

The memory 86 may also include the track 22 and/or a track increment 88. The hard disk drive 10 may operate by erasing N tracks with the wide track eraser 24. N may be considered the number of tracks erased per operation. N may approximate the ratio of the erasure pole width 76 to the writer width 78 as shown and discussed with regards to FIG. 6B shortly. Successive erasures may be offset by the track increment, that may be less than that ratio. N may further be at least eight. N may further be at least sixteen. Further preferred, N may be at least thirty two and more preferred, N may be at least sixty four, and may progress similarly to N of at least 1024.

The following figure shows a flowchart of at least one embodiment of the method, which may include arrows signifying a flow of control, and sometimes data, supporting various implementations of the method. These may include a program operation, or program thread, executing upon the computer 82, and/or a state transition in the finite state machine. The operation of starting a flowchart refers to entering a subroutine or a macro instruction sequence in the computer, and/or directing a state transition in the finite state machine, possibly while pushing a return state. The operation of termination in a flowchart refers to completion of those operations, which may result in a subroutine return in the computer, and/or popping of a previously stored state in the finite state machine. The operation of terminating a flowchart is denoted by a rounded box with the word “Exit” in it.

FIG. 4 shows some details of an embodiment the program system 90 of FIG. 3 including at least one of the following program steps. Program step 92 supports stimulating the wide track eraser 24 to erase the rotating disk surface 6 around the track 22. Program step 94 supports erasing the rotating disk surface using the wide track eraser every track increment 88 to create an erased disk surface. The reference number for N may be the track increment 88. Program step 96 supports servo-writing the erased disk surface to create a formatted disk surface. As used herein servo-writing the erased disk surface may include using the write head to create at least one and preferably at least two pairs of phase offset modulated signals written to the magnetic media on the rotating disk surface.

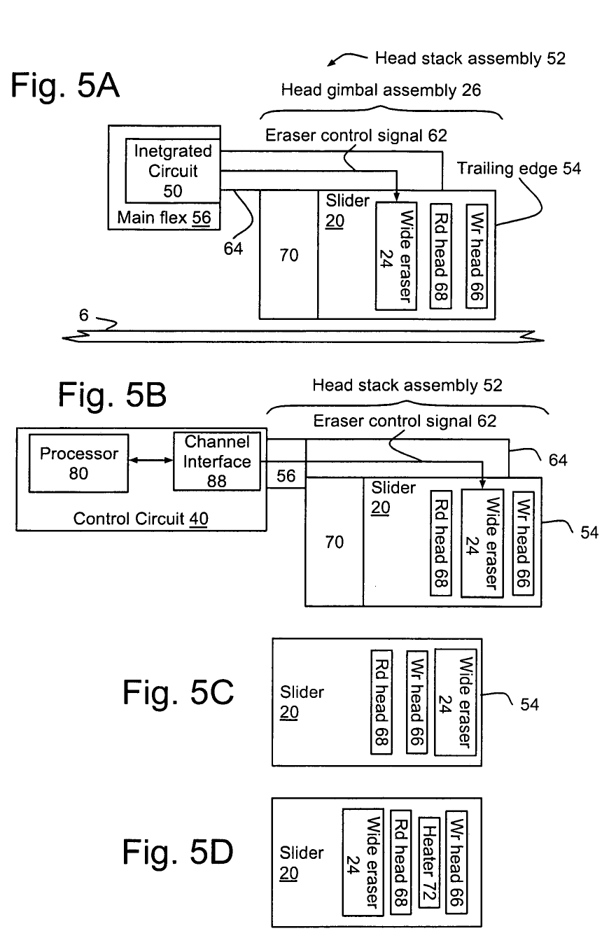

FIG. 5A shows some details of an embodiment of the head stack assembly 52 of FIGS. 2A and 3 where the main flex circuit 56 includes an integrated circuit 50 at least partly creating the eraser control signal 62 to stimulate the wide track eraser 24. The slider 20 is shown further including a write head 66 and a read head 68. Various embodiments of the invention include sliders with differing orderings of the wide track eraser, the read head, and the write head with regards the trailing edge 54 of the slider. In this example, the write head is closest, next the read head and then the wide track eraser.

The eraser control signal path carries the eraser control signal 64 and may be implemented as a single trace on the flexure finger sharing a common ground with other components or may preferably be implemented using a dual trace potentially minimizing effects from erasure on the other components of the slider. The single trace approach lends itself to single-ended drivers and the dual trace approach lends itself to differential drivers.

The integrated circuit 50 may stimulate the eraser control signal 64 and therefore the wide track eraser 24 using one or more of a direct current, an alternating current, and/or a square wave. The current of the eraser control signal may preferably be about 50 milliamps (mA), although this may vary to higher and/or lower amounts in various embodiments of the invention. In certain embodiments, the integrated circuit may act as the preamplifier for the read head 68.

FIG. 5B shows an example of the control circuit 40 of FIGS. 1 and 3 including a channel interface 88 at least partly controlling the eraser control signal 62. The processor 80 is controllably coupled to the channel interface. And the slider 20 includes the write head 66 closest to the trailing edge 54, followed by the wire track eraser, and then the read head 68.

FIG. 5C shows another example of the slider 20 with the wide track eraser 24 closest to the trailing edge 54, and FIG. 5D shows the slider further including a vertical micro-actuator, preferably using a thermal mechanical property and referred to herein as a heater 72. The slider of FIG. 5D will be further shown in two configurations in FIGS. 6A to 7B.

FIG. 6A shows an embodiment of the invention's slider 20 of FIG. 5D including a longitudinal recording write head 66 closest to the trailing edge 54, followed by a heater 72, a giant magneto-resistive read head 68 and then an embodiment of the wide track eraser 24. This embodiment of the wide track eraser includes an eraser coil 102 wrapped around a wide track erasure pole 100. Some further details of this slider are shown in FIGS. 6B and 6C: FIG. 6B shows the layers the slider as seen from the rotating disk surface 6. The writer width 78 and the erasure pole width 76 are shown. FIG. 6C shows some details of the wide track eraser including the eraser coil wrapped around the wide track erasure pole seen in cross section through the cut line A-A of FIG. 6A.

The write top pole P2 and the bottom pole P1 generate a magnetic field for writing data on the rotating disk surface 6. Unfortunately such write head can write only one track per one revolution of disk rotation, making it inefficient for erasing all the tracks because of its narrow write track width. For a hard disk drive 10 that satisfies the 3.5 inch form factor, the distance from the inside diameter to outside diameter is about 32 millimeters (mm). With a typical track width of 0.1 micro-meters (μm) and assuming it takes just one write pass to erase a track, a hard disk drive rotating its disks at 7200 revolutions per minute (RPM) it would take nearly 45 minute to erase one disk surface:

$$\begin{matrix}\frac{TrackLength}{TrackWidth} = TotalTracks = \frac{32 mm}{0.1 µm \text{/} Track} = 3.2 \times {10}^{5} Tracks & ( 1 ) \\ \frac{TotalTracks}{120 tracks \text{/} sec} = \frac{3.2 \times {10}^{5} Tracks}{120 tracks \text{/} sec} = 2.667 \times {10}^{3} sec = 44.44 min & ( 2 )\end{matrix}$$

Often the track width may be defined by the width of top pole and skew angle for a write head 66 employing a longitudinal recording scheme. In case of perpendicular magnetic recording, the write track width may be defined by the main pole width and skew angle.

An overcoat as shown in FIGS. 6A and 7A will refer to a deposited layer at the trailing edge 54 of a slider 20 that may contain Alumina or Al₂O₃. Also, while the substrate may vary, it may contain Aluminum, Titanium and Carbon possibly as represented by the chemical formula AlTiC.

The invention's slider 20 provides far faster erasure than the slider of the prior art because the ratio of the erasure pole width 76 to the writer width 78 is large, potentially as large as 100 and in some embodiments may be as large as 1,000. This ratio may approximate the track increment N 88. In erasing the rotating disk surface 6 around the track 22, the hard disk drive may not use the servo-written patterns because they are being erased. Suppose the ratio is about 100, even if track positioning has to allow for some overlap, say 16 tracks on each side, the track increment may be at least 64. Using the previously developed formulas, the time to erase the said disk surface goes from 45 minutes to 45 seconds. Even higher ratios may be more efficient.

This is a significant advantage in the manufacturing of hard disk drives 10, where sometimes the disk surface has been incorrectly initialized and must be erased before it can be reinitialized. Erasing one disk surface may take 45 minutes, but erased both sides of a dual disk hard disk drive may take 3 hours with the prior art sliders. However, with the improved performance provided by embodiments of this invention, it may take less than 3 minutes.

FIG. 7A shows another embodiment of the slider 20 of FIG. 5D including a perpendicular recording write head 66, followed by a heater 72, a tunneling magneto-resistive read head 68, and a wide track eraser 24. FIG. 7B shows the layers the slider as seen from the rotating disk surface 6. The wide track eraser includes a pancake coil 112 wrapped about the coupling of a first eraser pole 110 and a second eraser pole 114.

The preceding embodiments provide examples of the invention, and are not meant to constrain the scope of the following claims.

What is claimed is:

1. A hard disk drive comprising:
a disk base;
a spindle motor mounted on said disk base, said spindle motor rotatably coupled to a least one disk to create at least one rotating disk surface;
a voice coil motor pivotably mounted to said disk base, said voice coil motor including at least one actuator arm to move a head gimbal assembly including a slider, said slider including a wide track eraser, to position said wide track eraser to erase adjacent tracks and servo-patterning around a track on said rotating disk surface; and
a control circuit configured to control said wide track eraser.

2. The hard disk drive of claim 1, further comprising a read head, said read head configured to emply a member of the group consisting of a giant magneto-resistive effect and a tunneling magneto-resistive effect.

3. The hard disk drive of claim 1, further comprising a write head, wherein said write head is a member of the group consisting of a perpendicular recording write head and a longitudinal recording write head.

4. The hard disk drive of claim 1, wherein said control circuit configured to control said wide track eraser further comprises said control circuit controllably coupled to said eraser control signal path.

5. The hard disk drive of claim 1, wherein said control circuit is controllably coupled via an integrated circuit to said eraser control signal path.

6. The hard disk drive of claim 1, wherein said control circuit comprises at least one processor configured to control said wide track eraser.

7. The hard disk drive of claim 6, wherein said processor is controllably coupled to a channel interface to at least partly create an eraser control signal path to said wide track eraser.

8. The hard disk drive of claim 6, wherein said processor includes at least one instance of a controller, and wherein said controller includes at least one computer accessibly coupled via a buss to a memory, said computer is instructed by a program system including at least one program step residing in said memory.

9. The hard disk drive of claim 8, wherein said program system includes at least one of the program steps of:
stimulating said wide track eraser to erase said rotating disk surface around said track; and
erasing said rotating disk surface by using said wide track eraser every N of said tracks, whereby said N is at least four.

10. The hard disk drive of claim 1, wherein said write track eraser includes an eraser coil wrapped around a wide track erasure pole.

11. The hard disk drive of claim 1, wherein write track eraser includes a pancake coil wrapped about the coupling of a first eraser pole and a second eraser pole.

12. A method, comprising the step of:
erasing a hard disk drive including a rotating disk surface accessed by a slider including a wire track eraser, further comprising the step of:
erasing said rotating disk surface by using said wide track eraser every N tracks, whereby said N is at least four.

13. A slider for use in a hard disk drive, said slider comprising:
a wide track eraser; and
at least one eraser control signal path configured to stimulate said wide track eraser.

14. The slider of claim 13, further comprising a read head; wherein to read said track on said rotating disk surface said read head employs a member of the group consisting of a giant magneto-resistive effect and a tunneling magneto-resistive effect.

15. The slider of claim 14, further comprising a write head, said write head being member of the group consisting of a perpendicular recording write head and a longitudinal recording write head.

16. The slider of claim 15, wherein said wide track eraser includes an eraser coil wrapped around a wide track erasure pole.

17. The slider of claim 15, wherein wide track eraser includes a pancake coil wrapped about the coupling of a first eraser pole and a second eraser pole.

18. A head gimbal assembly for a hard disk drive, comprising:
a slider including a wide track eraser electrically coupled to an eraser control signal path; and
a flexure finger electrically coupled to said slider to at least partially provide said eraser control signal path.

19. A head stack assembly for a hard disk drive, comprising:
a slider including a wide track eraser electrically coupled to an eraser control signal path;
a flexure finger electrically coupled to said slider to at least partially provide said eraser control signal path; and
a main flex circuit electrically coupled to said flexure finger to further provide said eraser control signal path.

20. The head stack assembly of claim 21, wherein said main flex circuit includes an integrated circuit electrically coupled to said eraser control signal path.

21. A control circuit for a hard disk drive, comprising:
a processor configured to stimulate a wide track eraser included in a slider to erase around a track on a rotating disk surface.

22. The control circuit of claim 23, wherein said processor includes at least one instance of a controller; wherein said controller includes at least one computer accessibly coupled via a buss to a memory, said computer is configured to be directed by a program system including at least one program step residing in said memory.

23. The control circuit of claim 24, wherein said program system includes at least one of the program steps of:
stimulating said wide track eraser to erase said rotating disk surface around said track; and
erasing said rotating disk surface by using said wide track eraser every N of said tracks, whereby said N is at least four.
